(19) United States
(12) Patent Application Publication
(10) Pub. No.: US 2025/0272487 A1
(43) Pub. Date: Aug. 28, 2025

(54) SYSTEMS AND METHODS FOR ENHANCED TEXT RETRIEVAL WITH TRANSFER LEARNING

(71) Applicant: Salesforce, Inc., San Francisco, CA (US)

(72) Inventors: Rui Meng, San Francisco, CA (US); Ye Liu, Fremont, CA (US); Shafiq Rayhan Joty, Palo Alto, CA (US); Caiming Xiong, San Jose, CA (US); Yingbo Zhou, Palo Alto, CA (US); Semih Yavuz, Redwood City, CA (US)

(21) Appl. No.: 18/744,106

(22) Filed: Jun. 14, 2024

Related U.S. Application Data
(60) Provisional application No. 63/557,220, filed on Feb. 23, 2024.

(51) Int. Cl. G06F 40/279

(52) U.S. Cl. CPC G06F 40/279

(57) ABSTRACT

A method of training a neural network model for improved embedding performance is provided. A first plurality of data samples are received via a data interface. A plurality of batches are generated, including a first batch that includes data samples associated with a single first task, and a second batch that includes data samples associated with a single second task. A training process to the neural network model is performed using the plurality of batches. The training includes computing a first loss based on a first loss objective function customized for the first task and a second loss based on a second loss objective function customized for the second task, and updating parameters of the neural network model based on the first loss and the second loss via backpropagation.

### CROSS REFERENCE(S)

The instant application is a nonprovisional of and claims priority under 35 U.S.C. 119 to U.S. provisional application No. 63/557,220, filed Feb. 23, 2024, which is hereby expressly incorporated by reference herein in their entirety.

### TECHNICAL FIELD

The embodiments relate generally to machine learning systems for natural language processing (NLP), and more specifically to systems and methods for enhanced text retrieval with transfer learning.

### BACKGROUND

Machine learning systems have been widely used in natural language processing. For example, machine learning systems using text-embedding models are designed to understand, interpret, and generate human language in a way that computers can process. These models work by converting text into numerical representations, known as embeddings, which capture the semantic and syntactic essence of the language. This transformation allows computers to perform complex language-based tasks by analyzing these numerical vectors instead of the raw text.

With the expanding range of NLP applications and the growing complexity and volume of textual data, there is a need for improved text embedding techniques.

### BRIEF DESCRIPTION OF THE DRAWINGS

FIG. 1 is a simplified diagram illustrating a computing device implementing a text embedding framework, according to some embodiments.

FIG. 2 is a simplified block diagram of a networked system suitable for implementing the text embedding framework described in FIG. 1 and other embodiments described herein.

FIG. 3 is a simplified diagram illustrating a neural network structure, according to some embodiments.

FIG. 4 is a simplified diagram illustrating using pretrained LLM for embedding model, according to some embodiments described herein.

FIG. 5 is a simplified diagram illustrating an example multi-task transfer learning process, according to some embodiments described herein.

FIGS. 6-7 illustrates example embedding performance improvement of the text embedding framework described, according to one embodiment described herein.

FIGS. 8-9 illustrate task-homogeneous batching for training a neural network model (e.g., pretrained LLM) for improved embedding performance, according to one embodiment described herein.

FIGS. 10-12 illustrate experiment data for hard negative strategies for training a neural network model (e.g., pretrained LLM) for improved embedding performance, according to one embodiment described herein.

FIG. 13 is an example logic flow diagram illustrating a method of training a neural network model (e.g., pretrained LLM) for improved embedding performance, according to some embodiments described herein.

FIGS. 14-16 provide example experimental results illustrating example data performance of the text embedding model described in relation to FIGS. 1-13, according to some embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

Generative large language models (LLMs) have revolutionized natural language processing, offering impressive capabilities in text generation, translation, summarization, and more. However, these generative LLMs often exhibit limitations in embedding performance. Embeddings are vector representations of words, phrases, or entire sentences, that capture semantic meaning. High quality embeddings are crucial for various downstream tasks such as similarity searches, clustering, and classification. Despite their generative capabilities, generative LLMs (e.g., Mistral 7B, Llama 2 70B, Gemini Pro, GPT 4) have low embedding performance compared to embedding models like SGPT 5.8B, Instructor XL, etc. One reason for the low embedding performance of the generative LLMs is training objective mismatch, where the generative LLMs are primarily trained to predict the next word in a sequence, optimizing for coherence and contextual relevance. Such an objective differs from that of models for generating embeddings, which are primarily trained to capture semantic relationships between words/phrases. Another reason is that generative LLMs often operate in high-dimensional spaces, which allow them to generate detailed and contextual rich text. However, it can lead to embeddings that are not as compact or semantically meaningful as those generated by embedding models.

In view of the need for improved embedding performance for LLMs, embodiments described herein provide a text embedding framework by using an innovative approach to train LLMs as embedding models using transfer learning. Various techniques are used to improve embedding performance, including for example, task-homogenous batching and strategies for hard negative selection.

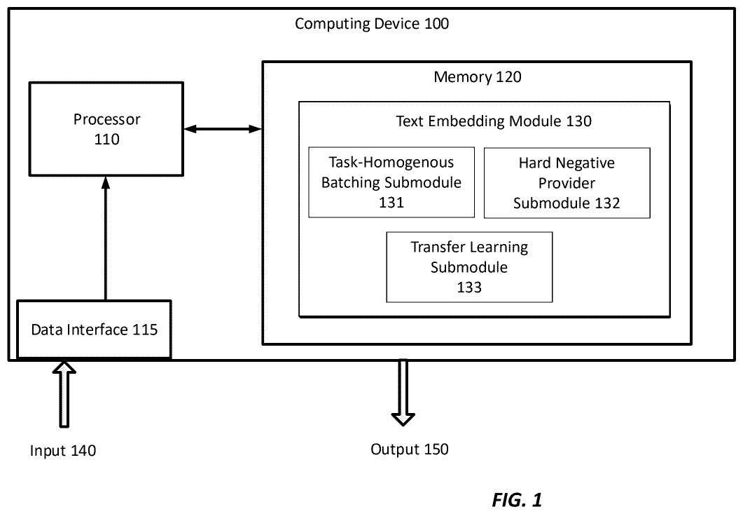

FIG. 1 is a simplified diagram illustrating a computing device implementing the text embedding with transfer learning framework described throughout the specification, according to one embodiment described herein. As shown in FIG. 1, computing device 100 includes a processor 110 coupled to memory 120. Operation of computing device 100 is controlled by processor 110. And although computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 100. Computing device 100 may be implemented as a stand-alone subsystem, as a board added to a computing device, and/or as a virtual machine.

Memory 120 may be used to store software executed by computing device 100 and/or one or more data structures used during operation of computing device 100. Memory 120 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 110 and/or memory 120 may be arranged in any suitable physical arrangement. In some embodiments, processor 110 and/or memory 120 may be implemented on a same board, in a same package (e.g., system-in-package), on a same chip (e.g., system-on-chip), and/or the like. In some embodiments, processor 110 and/or memory 120 may include distributed, virtualized, and/or containerized computing resources. Consistent with such embodiments, processor 110 and/or memory 120 may be located in one or more data centers and/or cloud computing facilities.

In some examples, memory 120 may include non-transitory, tangible, machine readable media that includes executable code that when run by one or more processors (e.g., processor 110) may cause the one or more processors to perform the methods described in further detail herein. For example, as shown, memory 120 includes instructions for text embedding module 130 that may be used to implement and/or emulate the systems and models, and/or to implement any of the methods described further herein. A text embedding module 130 may receive input 140 such as an 3D input via the data interface 115 and generate an output 150 which may be a prediction of the 3D classification task.

The data interface 115 may comprise a communication interface, a user interface (such as a voice input interface, a graphical user interface, and/or the like). For example, the computing device 100 may receive the input 140 (such as a training dataset) from a networked database via a communication interface. Or the computing device 100 may receive the input 140 from a user via the user interface.

In some embodiments, the text embedding module 130 is configured to perform a classification task. The text embedding module 130 may further include a task-homogenous batching submodule 131, a hard negative provider submodule 132, and a transfer learning submodule 133, which are all further described below. In one embodiment, the text embedding module 130 and its submodules 131-133 may be implemented by hardware, software and/or a combination thereof.

In one embodiment, the text embedding module 130 and one or more of its submodules 131-133 may be implemented via an artificial neural network. The neural network comprises a computing system that is built on a collection of connected units or nodes, referred to as neurons. Each neuron receives an input signal and then generates an output by a non-linear transformation of the input signal. Neurons are often connected by edges, and an adjustable weight is often associated to the edge. The neurons are often aggregated into layers such that different layers may perform different transformations on the respective input and output transformed input data onto the next layer. Therefore, the neural network may be stored at memory 120 as a structure of layers of neurons, and parameters describing the non-linear transformation at each neuron and the weights associated with edges connecting the neurons. An example neural network may be PointNet++, PointBERT, PointMLP, and/or the like.

In one embodiment, the neural network based text embedding module 130 and one or more of its submodules 131-133 may be trained by updating the underlying parameters of the neural network based on the loss described in relation to training the neural network based 3D encoder described in detail below. For example, given the loss computed according to Eqs. (4) and (5), the negative gradient of the loss function is computed with respect to each weight of each layer individually. Such negative gradient is computed one layer at a time, iteratively backward from the last layer to the input layer of the neural network. Parameters of the neural network are updated backwardly from the last layer to the input layer (backpropagating) based on the computed negative gradient to minimize the loss. The backpropagation from the last layer to the input layer may be conducted for a number of training samples in a number of training epochs. In this way, parameters of the neural network may be updated in a direction to result in a lesser or minimized loss, indicating the neural network has been trained to generate 3D representations aligned with the text representations and image representations.

Some examples of computing devices, such as computing device 100 may include non-transitory, tangible, machine readable media that include executable code that when run by one or more processors (e.g., processor 110) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

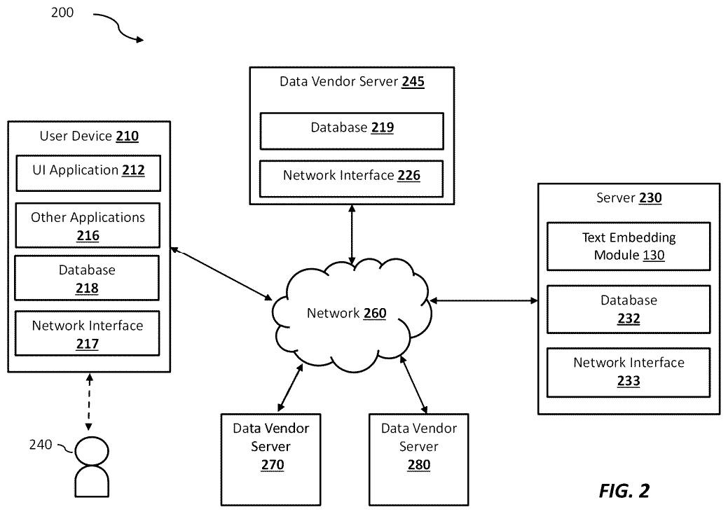

FIG. 2 is a simplified block diagram of a networked system suitable for implementing the 3D visual understanding framework in embodiments described herein. In one embodiment, block diagram 200 shows a system including the user device 210 which may be operated by user 240, data vendor servers 245, 270 and 280, server 230, and other forms of devices, servers, and/or software components that operate to perform various methodologies in accordance with the described embodiments. Exemplary devices and servers may include device, stand-alone, and enterprise-class servers which may be similar to the computing device 100 described in FIG. 1, operating an OS such as a MICROSOFT® OS, a UNIX® OS, a LINUX® OS, or other suitable device and/or server-based OS. It can be appreciated that the devices and/or servers illustrated in FIG. 2 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 210, data vendor servers 245, 270 and 280, and the server 230 may communicate with each other over a network 260. User device 210 may be utilized by a user 240 (e.g., a driver, a system admin, etc.) to access the various features available for user device 210, which may include processes and/or applications associated with the server 230 to receive an output data anomaly report.

User device 210, data vendor server 245, and the server 230 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

User device 210 may be implemented as a communication device that may utilize appropriate hardware and software configured for wired and/or wireless communication with data vendor server 245 and/or the server 230. For example, in one embodiment, user device 210 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 210 of FIG. 2 contains a user interface (UI) application 212, and/or other applications 216, which may correspond to executable processes, procedures, and/or applications with associated hardware. For example, the user device 210 may receive a message indicating a classification of a 3D classification task from the server 230 and display the message via the UI application 212. In other embodiments, user device 210 may include additional or different modules having specialized hardware and/or software as required.

In one embodiment, UI application 212 may communicatively and interactively generate a UI for an AI agent implemented through the text embedding module 130 (e.g., an LLM agent) at server 230. In at least one embodiment, a user operating user device 210 may enter a user utterance, e.g., via text or audio input, such as a question, uploading a document, and/or the like via the UI application 212. Such user utterance may be sent to server 230, at which text embedding module 130 may generate a response by performing the specific task (e.g. text retrieval) associated with the user input. The text embedding module 130 may thus cause a display of task results (e.g., retrieved texts) at UI application 212 and interactively update the display in real time with the user utterance.

In various embodiments, user device 210 includes other applications 216 as may be desired in particular embodiments to provide features to user device 210. For example, other applications 216 may include security applications for implementing client-side security features, programmatic client applications for interfacing with appropriate application programming interfaces (APIs) over network 260, or other types of applications. Other applications 216 may also include communication applications, such as email, texting, voice, social networking, and IM applications that allow a user to send and receive emails, calls, texts, and other notifications through network 260. For example, the other application 216 may be an email or instant messaging application that receives a prediction result message from the server 230. Other applications 216 may include device interfaces and other display modules that may receive input and/or output information. For example, other applications 216 may contain software programs for asset management, executable by a processor, including a graphical user interface (GUI) configured to provide an interface to the user 240 to view the prediction/classification result.

User device 210 may further include database 218 stored in a transitory and/or non-transitory memory of user device 210, which may store various applications and data and be utilized during execution of various modules of user device 210. Database 218 may store user profile relating to the user 240, predictions previously viewed or saved by the user 240, historical data received from the server 230, and/or the like. In some embodiments, database 218 may be local to user device 210. However, in other embodiments, database 218 may be external to user device 210 and accessible by user device 210, including cloud storage systems and/or databases that are accessible over network 260.

User device 210 includes at least one network interface component 219 adapted to communicate with data vendor server 245 and/or the server 230. In various embodiments, network interface component 219 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 245 may correspond to a server that hosts one or more of the databases 203a-n (or collectively referred to as 203) to provide training datasets including training images and questions to the server 230. The database 203 may be implemented by one or more relational database, distributed databases, cloud databases, and/or the like.

The data vendor server 245 includes at least one network interface component 226 adapted to communicate with user device 210 and/or the server 230. In various embodiments, network interface component 226 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 245 may send asset information from the database 203, via the network interface 226, to the server 230.

The server 230 may be housed with the text embedding module 130 (also referred to as ULIP-2 module 130) and its submodules described in FIG. 1. In some implementations, module 130 may receive data from database 219 at the data vendor server 245 via the network 260 to generate a classification for a classification task. The generated classification may also be sent to the user device 210 for review by the user 240 via the network 260.

The database 232 may be stored in a transitory and/or non-transitory memory of the server 230. In one implementation, the database 232 may store data obtained from the data vendor server 245. In one implementation, the database 232 may store parameters of the 3D visual understanding model 130. In one implementation, the database 232 may store previously generated classifications, and the corresponding input feature vectors.

In some embodiments, database 232 may be local to the server 230. However, in other embodiments, database 232 may be external to the server 230 and accessible by the server 230, including cloud storage systems and/or databases that are accessible over network 260.

The server 230 includes at least one network interface component 233 adapted to communicate with user device 210 and/or data vendor servers 245, 270 or 280 over network 260. In various embodiments, network interface component 233 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 260 may be implemented as a single network or a combination of multiple networks. For example, in various embodiments, network 260 may include the Internet or one or more intranets, landline networks, wireless networks, and/or other appropriate types of networks. Thus, network 260 may correspond to small scale communication networks, such as a private or local area network, or a larger scale network, such as a wide area network or the Internet, accessible by the various components of system 200.

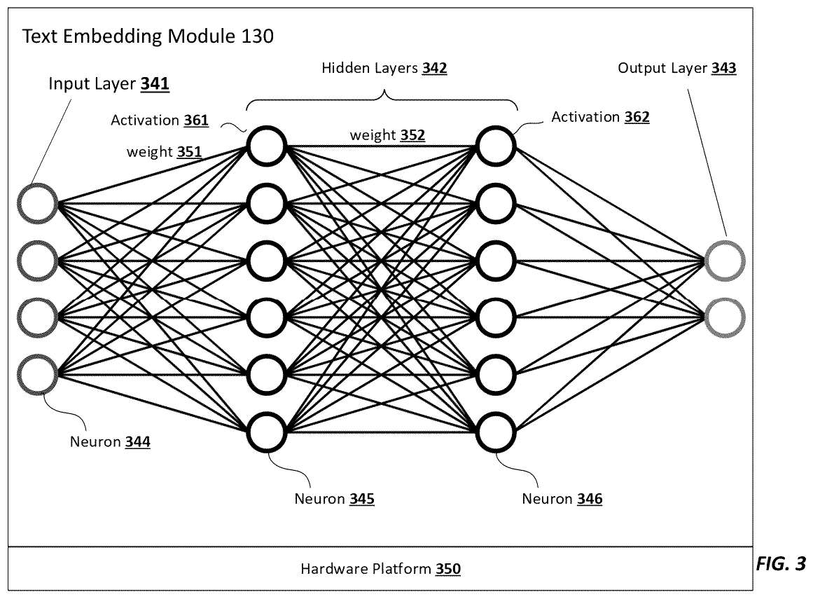

FIG. 3 is a simplified diagram illustrating an example neural network structure implementing one or more neural network models of the text embedding module 130 described in FIG. 1, according to some embodiments.

Referring to FIG. 17, a simplified diagram illustrates an example neural network structure implementing the text embedding module 130 described in FIG. 1, according to one embodiment described herein. In one embodiment, the text embedding module 130 and/or one or more of its submodules 131-133 may be implemented via an artificial neural network structure shown in FIG. 17. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer receives the input data (e.g., an input question). The number of nodes (neurons) in the input layer 341 may be determined by the dimensionality of the input data (e.g., the length of a vector of the input question). Each node in the input layer represents a feature or attribute of the input.

The hidden layers 342 are intermediate layers between the input and output layers of a neural network. It is noted that two hidden layers 342 are shown in FIG. 3 for illustrative purpose only, and any number of hidden layers may be utilized in a neural network structure. Hidden layers 342 may extract and transform the input data through a series of weighted computations and activation functions.

For example, as discussed in FIG. 1, the text embedding module 130 receives an input 140 of a question, and its semantic parsing submodule generates an output of a representation corresponding to the input question. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the text embedding module 130 and/or one or more of its submodules 131-133 may comprise the transformative neural network structure of layers of neurons, and weights and activation functions describing the non-linear transformation at each neuron. Such a neural network structure is often implemented on one or more hardware processors 110, such as a graphics processing unit (GPU). An example neural network may be a T5 model, a generative encoder-decoder model (e.g., FiD), and/or the like.

In one embodiment, the text embedding module 130 and its submodules 131-?? may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, representing a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for input tokens to be processed through the multiple layers to generate an output in a Transformer architecture often entails hundreds of teraflops (trillions of floating-point operations) of computation.

In one embodiment, the text embedding module 130 and its submodules 131-133 may be implemented by hardware, software and/or a combination thereof. For example, the text embedding module 130 and its submodules 131-133 may comprise a specific neural network structure implemented and run on various hardware platforms 350, such as but not limited to CPUs (central processing units), GPUs (graphics processing units), FPGAs (field-programmable gate arrays), Application-Specific Integrated Circuits (ASICs), dedicated Al accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware platform 350 used to implement the neural network structure is specifically configured depends on factors such as the complexity of the neural network, the scale of the tasks (e.g., training time, input data scale, size of training dataset, etc.), and the desired performance.

In one embodiment, the text embedding module 130 and one or more of its submodules 131-133 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as input questions and paragraphs are fed into the neural network. The data flows through the network's layers 341, 342, with each layer performing computations based on its weights, biases, and activation functions until the output layer 343 produces the network's output 150.

The output generated by the output layer 343 is compared to the expected output (e.g., a “ground-truth” such as the corresponding correct answer for an input question) from the training data, to compute a loss function that measures the discrepancy between the predicted output and the expected output. For example, the loss function may be cross entropy, MMSE, any other suitable loss functions, or a combination thereof. Given the loss, the negative gradient of the loss function is computed with respect to each weight of each layer individually. Such a negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, text embedding module 130 and its submodules 131-133 may be housed at a centralized server (e.g., computing device 100) or one or more distributed servers. For example, one or more of text embedding module 130 and its submodules 131-133 may be housed at external server(s). The different modules may be communicatively coupled by building one or more connections through application programming interfaces (APIs) for each respective module. Additional network environment for the distributed servers hosting different modules and/or submodules may be discussed in FIG. 2.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as performing question answering tasks.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in language processing systems.

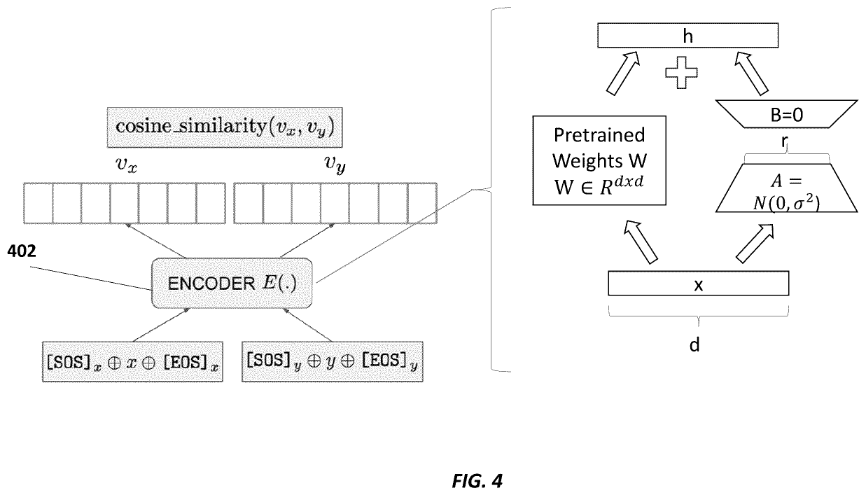

Referring to FIG. 4, a simplified block diagram illustrates a framework to use a pretrained LLM (e.g., a pretrained generative LLM) as the backbone/fundamental model of an embedding model, according to one embodiment described herein. Specifically, a pretrained LLM 402 is used as a bidirectional encoder, which is capable to capture comprehensive contextual information from both preceding and succeeding segments of text. This bidirectional encoding strategy allows the model to effectively understand the nuances and dependencies within the input sequences. Further, as shown in FIG. 4, EOS (End of Sequence) pooling technique is used, which aggregates information from the entire sequence (e.g., input x, input y), while the significance of the final tokens in the input may be emphasized. The LLM/encoder 402 generates encoded vector Vx and Vy for input sequences x and y respectively. Functions (e.g., comparison using cosine_similarity function) may be performed using the encoded vectors Vx and Vy for generating task result.

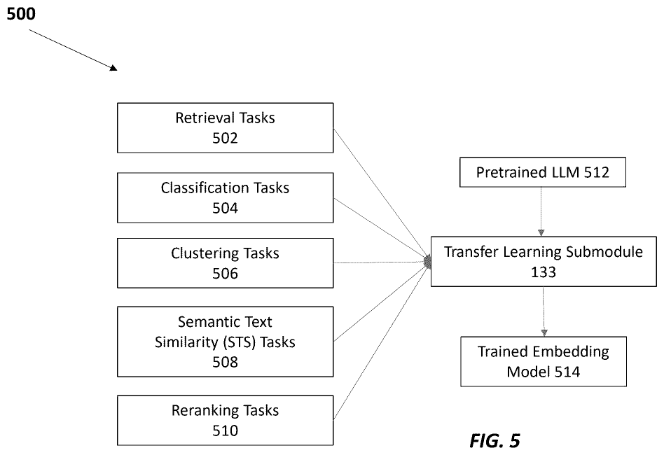

Referring to FIG. 5, illustrated is a framework 500 for training a pretrained LLM for text embedding, according to one embodiment described herein. As discussed above, a pretrained LLM generally has lower embedding performance compared to embedding models. As shown in FIG. 5, to improve the embedding performance of the pretrained LLM 512 (e.g., E5-mistral-7b-instruct, Mistral-7B-v0.1, or any other suitable pretrained LLM), a training process using transfer learning is performed by the transfer learning submodule 133 on the pretrained LLM 512 to provide a trained embedding model 512 with improved embedding performance and thereby improved text retrieval performance.

As shown in FIG. 5, the framework 500 uses multi-task training, which benefits generalization. The multiple training tasks may include two or more of various types of tasks including for example, retrieval tasks 502, classification tasks 504, clustering tasks 506, semantic text similarity (STS) tasks 508, reranking tasks 510, any other suitable tasks, and/or a combination thereof. For example, embedding models experience a substantial enhancement in retrieval performance when they are integrated with clustering tasks 506. For further example, the effectiveness of embedding models can be further improved through knowledge transfer from multiple tasks. By explicitly guiding documents towards high-level tags, training with clustering data enables embedding models to navigate and retrieve information more effectively. In an example, three clustering datasets originated from the scientific domain are used, and in that example, incorporating additional clustering training yields significant improvements across all tasks. The clustering labels may encourage models to regularize the embeddings based on high-level concepts, resulting in better separation of data across different domains.

Moreover, generalization can be strengthened by employing multi-task training and adapting the models to specific tasks. This approach not only improves the accuracy of search results, but also ensures the adaptability of models to diverse domains and tasks, which is crucial for real-world application scenarios.

In some embodiments, for training the LLM as an embedding model, LoRA (Low-Rank Adaptation) is used, which may optimize the learning process by employing low-rank approximations, which efficiently handle high-dimensional data while mitigating computational complexity. This approach facilitates rapid convergence and enhances the model's ability to generalize across diverse datasets, ultimately contributing to improved performance and robustness in real-world applications.

In an example, a range of tasks are used for multi-task training of the pretrained LLM 512. For example, for retrieval tasks 502, the training utilizes data from MS-MARCO, NQ, FIQA, SciFact, NFCorpus, DBPedia, FEVER, HotpotQA, Quora and NLI. For a retrieval task, the input may include a query and document. For example, with an input query “climate change effects,” the system will search through the document corpus to find and return documents related to the effects of climate change. Such data samples associated with the retrieval tasks may be included in the training samples for the multi-task training.

For classification tasks 504, datasets from AmazonReview, Emotion, MTOPIntent, ToxicConversation, and TweetSentiment are used. For example, for an email classification system, the input text is the email content, and the labels could be “spam” or “not spam.” If an email contains many unsolicited sales phrases, it would be classified under the “spam” category. Such data samples associated with the classification tasks may be included in the training samples for the multi-task training.

For clustering tasks 506, data from arXiv, bioRxiv, and medRxiv are used, with filters applied to exclude development and testing sets in the MTEB clustering framework. For example, a system performing a clustering task may use clustering to gather the news of the same case together according to the features extracted from the news. Such data samples associated with the clustering tasks may be included in the training samples for the multi-task training.

For STS tasks 508, data from STS12, STS22, and STSBenchmark are used. For example, if the input texts are “How can I reset my password?” and “What are the steps to change my password?,” the STS system evaluates the semantic similarity between these two sentences, and provide a score indicating the similarity of the two input texts. Such data samples associated with the STS tasks may be included in the training samples for the multi-task training.

For reranking tasks, data from SciDocs and StackOverFlowDupQuestions are used. For example, the reranking system may receive an input text and a list of additional texts as input, and generate a raking of the list of texts based on their similarities with the input text. Such data samples associated with the ranking tasks may be included in the training samples for the multi-task training.

In some embodiments, contrastive loss is used for the training utilizing in-batch negatives alongside expectational clustering and classification tasks. In some examples, the labels are treated as documents for these specific clustering and classification tasks. Contrastive loss may be exclusively applied to their respective negatives, omitting in-batch negatives. In experiments discussed below, results on the dev set of the MTEB benchmark. In the experiments, fine-tuning of the e5-mistral-7b-instruct model is performed for 200steps using a batch size of 2,048, a learning rate of 1e-5, and a warmup phase of 30 steps followed by a linear decay. Each query-document pair is batched with 7 hard negatives. A maximum sequence length of 128 for queries and 256 for documents is used. This fine-tuning process took approximately 15 hours on 8 A100 GPUs. LoRA adapters with rank r=8 are added to all linear layers, resulting in 21M trainable parameters.

Referring to FIG. 5, experiments results for embedding performance by training based on multiple tasks are illustrated. As shown in the experiment results 602, 604, 606, 608, and 610, using clustering tasks in training exhibit notable enhancements in retrieval performance across various applications. Further, as shown in the experiment results 612, 614, 616, 618, and 620, by using additional tasks for training, knowledge transfer further boosts the effectiveness of the embedding models. By leveraging knowledge learned from multiple tasks, the embedding models can capture a broader spectrum of semantic relationships and nuances within the data, which the robustness and generalization capabilities of embedding models, leading to significant improvements in various natural language processing tasks, such as information retrieval, similarity estimation, and document classification.

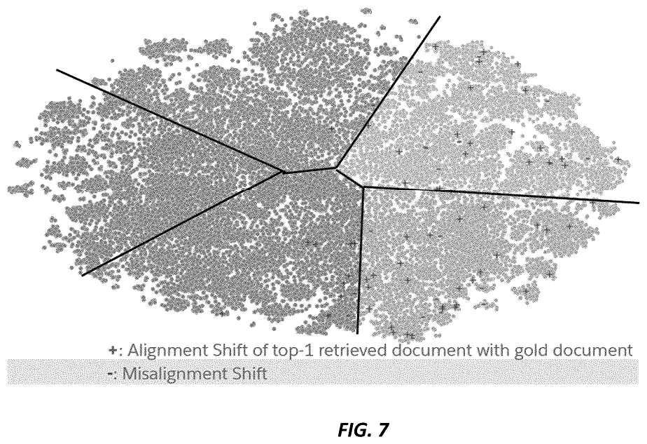

Referring to FIG. 7, illustrated is a visualization of the embedding performance in the experiment results. Specifically, it illustrates results retrieved top-1 document shift of the embedding model (with multi-task training including cluster tasks) as described in embodiments herein compared to the pre-trained LLM without multi-task training. The solid lines illustrate the boundaries among five clusters, “+” illustrates successful alignment shift of top-1 retrieved document with the gold document after multi-task training, and “−” illustrates misalignment shifts. The prevalence of “+” symbols, especially at cluster boundaries, underscores the role of clustering in refining document representations and improving separation, thereby bolstering overall document categorization and precision.

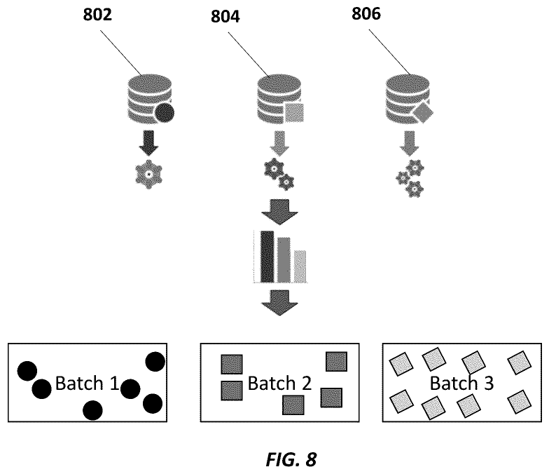

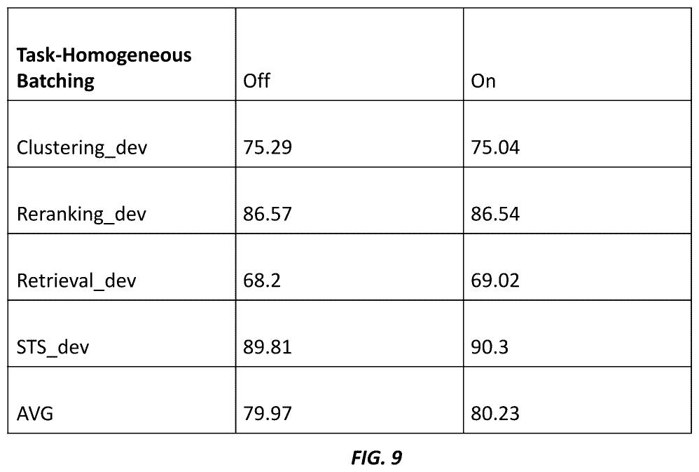

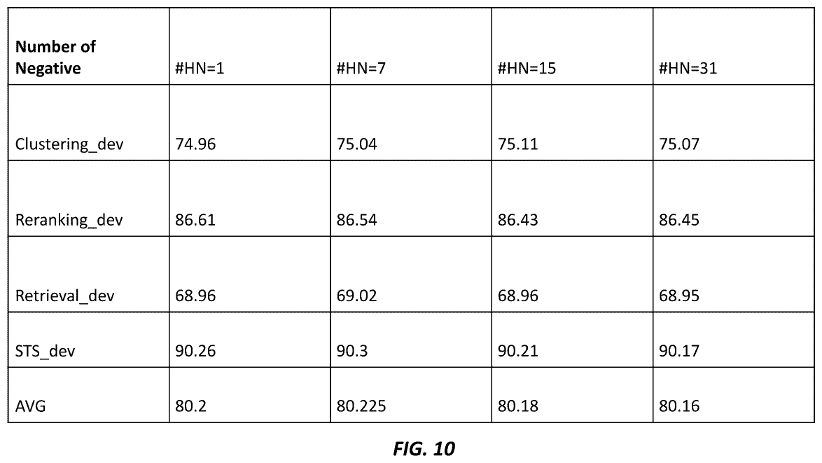

Referring to FIGS. 8-12, additional techniques for improving the embedding performance for the text embedding module are describes. Specifically, FIGS. 8-9 describe the task-homogenous batching technique that constructs batches consisting exclusively of samples from a single task for the multi-task training of the pretrained LLM. FIGS. 10-12 describe hard negative strategies for further improving the embedding performance.

Referring to FIG. 8, illustrated is an example of task-homogeneous batching according to an embodiment described herein. As shown in the example of FIG. 8, batches 1, 2, and 3 are constructed such that each of the batches consists exclusively of samples from a single task. For example, batch 1 includes exclusively samples from task 802, batch 2 includes exclusively samples from task 804, and batch 3 includes exclusively samples from task 806. Consequently, the in-batch negative becomes more challenging as other examples within the batch closely resemble the test case scenario.

Referring to FIG. 9, illustrated are the experimental results comparing cases where task-homogeneous batching is turned on and off. For retrieval tasks with task-homogeneous batching, there is a notable performance improvement of 0.8 points.

Referring to FIGS. 10-12, the text embedding framework as described in embodiments herein uses an effective training technique using “hard negatives.” Hard negatives are data points that are challenging for the models to distinguish from the positive ones. In experiment results described below, be default, the BGE-base model is used to mine the hard negatives.

In some embodiments, strategies to eliminate false negatives are implemented. In some examples, in the mined negatives, a considerable portion may be false negatives, meaning they are semantically identical to the corresponding positive documents but mistakenly treated as negatives. As such, it is crucial to implement a strategy (e.g., by providing a predetermined hard negative number, a predetermined batch size, etc.) to accurately and efficiently select hard negatives for embedding training, as it aids models in identifying the most relevant documents to a query.

In the experiment setting described above, the experiment results indicate that the range from 30 to 100 yields improved performance. This implies that the top-ranked documents (0-100) may include some false negatives, while those ranked lower (50-100) lack sufficient challenge. Therefore, finding the right tradeoff between these factors is important in contrastive training.

As shown in the example of FIG. 10, the strategy may include providing a predetermined number of hard negatives to be selected and used in the multi-task training. The quantity of hard negatives used in contrastive learning can significantly impact the model's learning dynamics. Including more hard negative prompts enables the model to differentiate more subtle distinctions, potentially enhancing its generalization capabilities. Nevertheless, the experiment findings suggest that the training process remains relatively stable regardless of the number of hard negatives utilized.

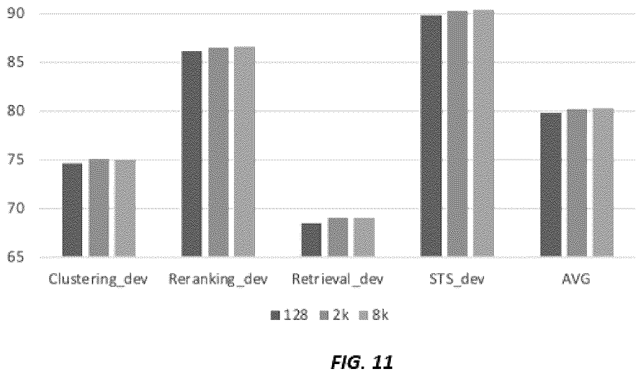

As shown in FIG. 11, the strategy may include providing a predetermined batch size. Specifically, leveraging larger batch sizes has proven advantageous, primarily due to the inclusion of more challenging negative examples. In the experiments described herein, GradCache is used to facilitate training with large batch sizes. Experiments with batch sizes of 128, 2,048, and 8,192 are conducted to assess the impact of batch size. Leveraging larger batch sizes (2K+) leads to considerable improvement compared to the smaller batch sizes (e.g., 128) conventionally used for fine-tuning. However, enlarging the batch size from 2048 to 8192 does not result in any significant change in performance.

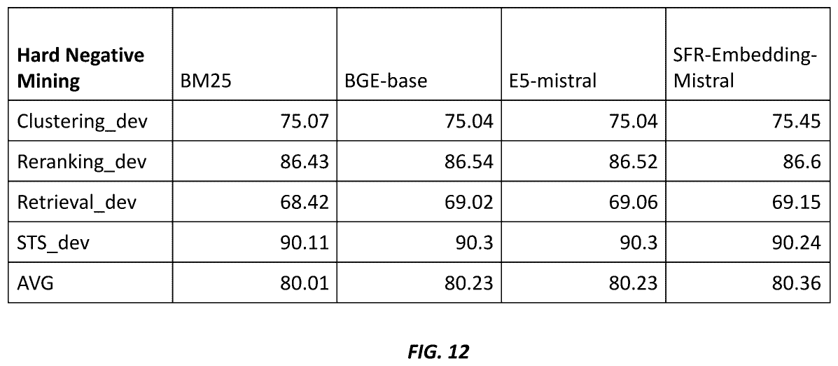

Referring to FIG. 12, the strategy may include choosing a specific model (e.g., teacher models) for hard negative mining. More advanced models are used to collect challenging hard negatives. As shown in FIG. 12, in the experiments described herein, four models are employed to investigate the impact of teacher models on mining hard negatives, spanning from the classic lexical model BM25 to advanced dense models, such as the model (SFR-Embedding-Mistral) described in embodiments herein. The findings indicate that the selected dense models serve as superior teacher models compared to BM25, and in general, more powerful models can yield more effective hard negatives (SFR-Embedding-Mistral>E5-Mistral>BGE-base).

### Example Workflows

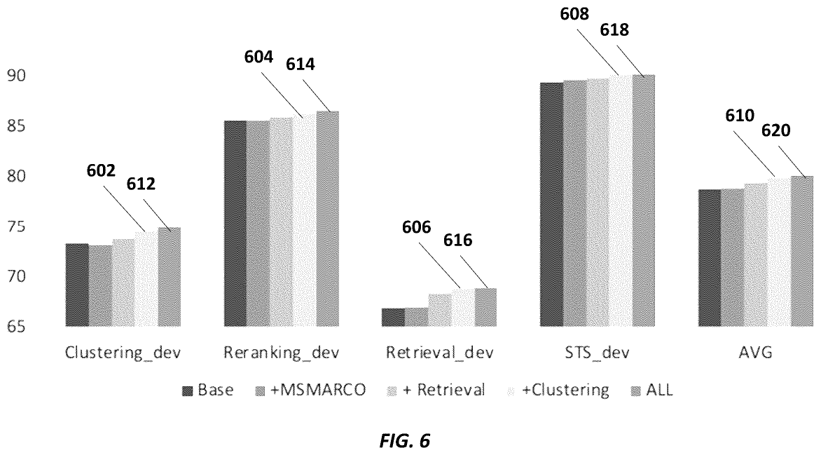

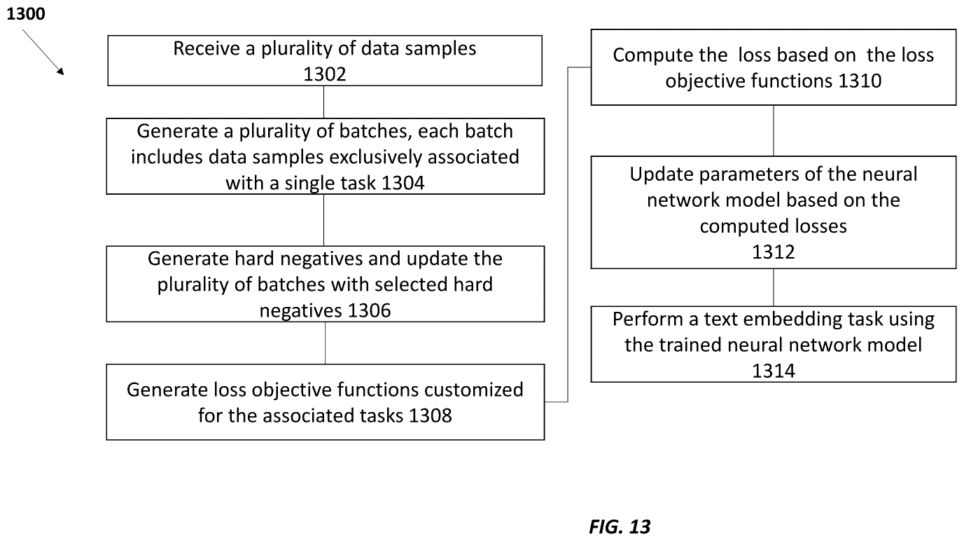

FIG. 13 is an example logic flow diagram illustrating a method of training a neural network model (e.g., pretrained LLM) for improved embedding and text retrieval performance based on the framework shown in FIGS. 1-12, according to some embodiments described herein. One or more of the processes of method 1300 may be implemented, at least in part, in the form of executable code stored on non-transitory, tangible, machine-readable media that when run by one or more processors may cause the one or more processors to perform one or more of the processes. In some embodiments, method 1300 corresponds to the operation of the text embedding module 130 (e.g., FIGS. 1A and 2) that performs training of the pretrained LLM for improved embedding performance.

As illustrated, the method 1300 includes a number of enumerated steps, but aspects of the method 1300 may include additional steps before, after, and in between the enumerated steps. In some aspects, one or more of the enumerated steps may be omitted or performed in a different order.

At step 1302, a plurality of data samples are received. Specifically, each data sample is associated with a specific task, and the plurality of data samples are associated with a plurality of tasks (e.g., retrieval task, clustering task, classification task, etc.). At step 1304, a plurality of batches are generated, each batch includes data samples exclusively associated with a single task. At step 1306, hard negatives are generated using a selected neural network model (e.g., a model more advanced than the pretrained LLM). A strategy (e.g., number of hard negatives, batch size, the type of model for mining the hard negatives, etc.) may be implemented to generate and select the hard negatives. These selected hard negatives are used to update the plurality of batches.

At step 1308, loss objective functions customized for the associated tasks are generated. At step 1310, losses based on these loss objective functions are computed. At step 1312, parameters of the neural network model are updated based on the computed losses. At step 1314, a text embedding task using the trained neural network model.

### Experimental Results

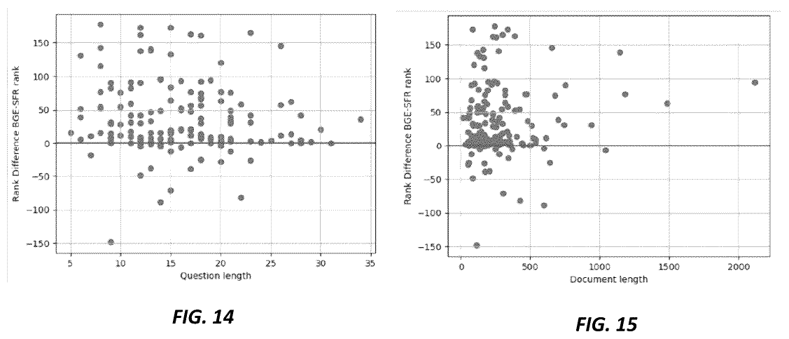

FIGS. 14-16 represent exemplary test results using embodiments described herein.

Referring to FIGS. 14 and 15, the difference in ranking of the positive documents for the BGE-large and the model (SFR-Embedding-Mistral) described in embodiments herein in relation to the length of the query/question (FIG. 14) and the length of the document (FIG. 15) is illustrated. More precisely, the y-axis captures the rank(gold-document|BGE-large)−rank(gold-document|SFR-Embedding-Mistral), meaning the higher the absolute value, the more contrast between the two models. In both figures, SFR-Embedding-Mistral model ranks positive documents better than the BGE model overall. More importantly, we observe that after a certain length threshold, i.e., 25 for queries and 700 for documents, BGE model is significantly less likely to rank the gold document higher than SFR-Embedding-Mistral owing to the inherent power of LLMs to represent long-context. It becomes particularly appealing for downstream RAG applications where keeping the document structure intact is indispensable. For example, the RAG system maintains the structure of long legal documents during summarization by understanding and retrieving various sections, ensuring the summary accurately captures the case's essence and legal reasoning, which is vital for legal contexts.

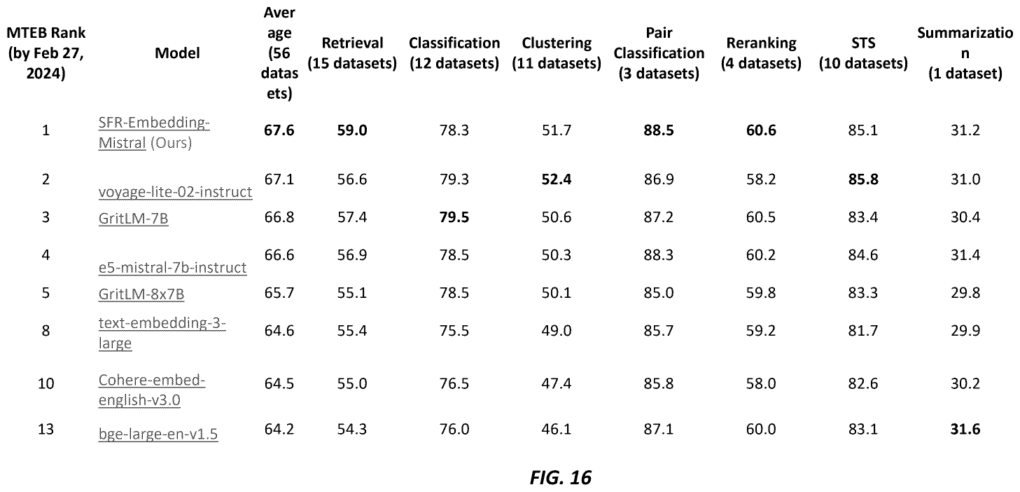

Next, full Evaluation on MTEB is discussed. MTEB (Massive Text Embedding Benchmark) is by far the most comprehensive benchmark for evaluating embedding models, encompassing 56 datasets across seven task types: seven tasks: classification, clustering, pair classification, re-ranking, retrieval, STS, and summarization. As shown in FIG. 16, as evidenced by the MTEB leaderboard (as of Feb. 27, 2024), the model as described in the embodiments herein (labeled “SFR-Embedding-Mistral”) claims the top spot among over 150 embedding models, including several proprietary ones such as voyage-lite-02-instruct, OpenAI text-embedding-3-large, and Cohere-embed-english-v3.0. Particularly noteworthy is its performance on retrieval tasks, which are considered the most pivotal among all MTEB task types. SFR-Embedding-Mistral excels with an average score of 59.0, surpassing the 2nd place model by a substantial margin (57.4). This outcome underscores the exceptional performance of our model across diverse tasks and domains.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of training a neural network model, the method comprising:
receiving, via a data interface, a first plurality of data samples;
generating a plurality of batches using the first plurality of data samples,
wherein a first batch includes data samples associated with a single first task, and wherein a second batch includes data samples associated with a single second task; and
performing a first training process to the neural network model using the plurality of batches, wherein the performing the first training process includes:
generating a first loss objective function for the first batch based on the first task;
generating a second loss objective function for the second batch based on the second task;
computing a first loss based on the first loss objective function;
computing a second loss based on the second loss objective function; and
updating parameters of the neural network model based on the first loss and the second loss via backpropagation; and
wherein the neural network model trained by the first training process is used to perform a text retrieval task based on text embedding.

2. The method of claim 1, wherein prior to the first training process, the neural network model is trained using a second training process using a second plurality of data samples.

3. The method of claim 1, wherein the neural network model includes a pre-trained generative large language model (LLM).

4. The method of claim 1, wherein the text retrieval task is different from the first task and the second task.

5. The method of claim 1, wherein the first loss objective function includes a first contrastive loss customized to the first task, and
wherein the second loss objective function includes a second contrastive loss customized to the second task.

6. The method of claim 1, wherein the performing the first training process includes:
generating a plurality of hard negatives for the first task;
selecting a predetermined number of hard negatives from the plurality of hard negatives for the first task; and
updating the first batch using the selected predetermined number of hard negatives.

7. The method of claim 6, wherein a pre-trained second neural network model is used to generate the plurality of hard negatives for the first task.

8. A system for providing a trained neural network, the system comprising:
a memory that stores a neural network model and a plurality of processor-executable instructions;
a communication interface that receives a first plurality of data samples; and
one or more hardware processors that read and execute the plurality of processor-executable instructions from the memory to perform operations comprising:
generating a plurality of batches using the first plurality of data samples,
wherein a first batch includes data samples associated with a single first task, and wherein a second batch includes data samples associated with a single second task; and
performing a first training process to the neural network model using the plurality of batches, wherein the performing the first training process includes:
generating a first loss objective function for the first batch based on the first task;
generating a second loss objective function for the second batch based on the second task;
computing a first loss based on the first loss objective function;
computing a second loss based on the second loss objective function; and
updating parameters of the neural network model based on the first loss and the second loss via backpropagation; and
wherein the neural network model trained by the first training process is used to perform a text retrieval task based on text embedding.

9. The system of claim 8, wherein prior to the first training process, the neural network model is trained using a second training process using a second plurality of data samples.

10. The system of claim 8, wherein the neural network model includes a pre-trained generative large language model (LLM).

11. The system of claim 8, wherein the text retrieval task is different from the first task and the second task.

12. The system of claim 8, wherein the first loss objective function includes a first contrastive loss customized to the first task, and
wherein the second loss objective function includes a second contrastive loss customized to the second task.

13. The system of claim 8, wherein the performing the first training process includes:
generating a plurality of hard negatives for the first task;
selecting a predetermined number of hard negatives from the plurality of hard negatives for the first task; and
updating the first batch using the selected predetermined number of hard negatives.

14. The system of claim 13, wherein a pre-trained second neural network model is used to generate the plurality of hard negatives for the first task.

15. A non-transitory machine-readable medium comprising a plurality of machine-executable instructions which, when executed by one or more processors, are adapted to cause the one or more processors to perform operations comprising:
receiving, via a data interface, a first plurality of data samples;
generating a plurality of batches using the first plurality of data samples,
wherein a first batch includes data samples associated with a single first task, and wherein a second batch includes data samples associated with a single second task; and
performing a first training process to a neural network model using the plurality of batches, wherein the performing the first training process includes:
generating a first loss objective function for the first batch based on the first task;
generating a second loss objective function for the second batch based on the second task;
computing a first loss based on the first loss objective function;
computing a second loss based on the second loss objective function; and
updating parameters of the neural network model based on the first loss and the second loss via backpropagation; and
wherein the neural network model trained by the first training process is used to perform a text retrieval task based on text embedding.

16. The non-transitory machine-readable medium of claim 15, wherein prior to the first training process, the neural network model is trained using a second training process using a second plurality of data samples.

17. The non-transitory machine-readable medium of claim 15, wherein the neural network model is a pre-trained generative large language model (LLM).

18. The non-transitory machine-readable medium of claim 15, wherein the text retrieval task is different from the first task and the second task.

19. The non-transitory machine-readable medium of claim 15, wherein the first loss objective function includes a first contrastive loss customized to the first task, and
wherein the second loss objective function includes a second contrastive loss customized to the second task.

20. The non-transitory machine-readable medium of claim 15, wherein the performing the first training process includes:
generating a plurality of hard negatives for the first task;
selecting a predetermined number of hard negatives from the plurality of hard negatives for the first task; and
updating the first batch using the selected predetermined number of hard negatives.
